(19) United States
(12) Patent Application Publication
(10) Pub. No.: US 2002/0067378 A1
(43) Pub. Date: Jun. 6, 2002

(54) Computer controlled user interactive display interfaces with three-dimensional control buttons

(75) Inventors: Sanaa F. Abdelhadi, Austin, TX (US); Hypatia Rojas, Round Rock, TX (US)

Correspondence Address: Volel Emile, International Business Machines Corporation, Intellectual Property Law Department, Internal Zip 4054, 11400 Burnet Road, Austin, TX, 78758, US

(73) Assignee: International Business Machines Corporation

(21) Appl. No.: 09/730,413

(22) Filed: Dec. 4, 2000

(51) Int. Cl. G06F 3/14

(52) U.S. Cl. 345/836; 345/840

(57) ABSTRACT

A virtual three-dimensional user interactive control button comprising a first face in a first of said three dimensions including a first user interactive element enabling a user to select a first function; a second face in a second of said three dimensions including a second user interactive element enabling a user to select a second function; and a third face in a third of said three dimensions including a third user interactive element enabling a user to select a third function. By combining such sets of three interactive elements, such as icons, into unitary compact and concise control buttons, considerable display space is conserved. Also, if the functions of the combined elements are related to each other, there is a considerable improvement in the organization of the display workspace.

### TECHNICAL FIELD

The present invention relates to user interactive computer supported display technology and particularly to graphical user interfaces which are user friendly and provide interactive users with an interface environment that is easy to use.

### BACKGROUND OF RELATED ART

The past decade has been marked by a technological revolution driven by the convergence of the data processing industry with the consumer electronics industry. This advance has been even further accelerated by the extensive consumer and business involvement in the Internet over the past two years. As a result of these changes, it seems as if virtually all aspects of human endeavor in the industrialized world require human-computer interfaces. There is a need to make computer directed activities accessible to a substantial portion of the world's population, which, up to a few years ago, was computer-illiterate or, at best, computer indifferent.

Two of the computer interface implementations that have played a major role in advancing user interfaces have been: display windows which make it possible for the user to simultaneously conduct many operations and sessions; and icons which make user interaction with the computer more intuitive and quicker. On the other hand, because of the increase in functions which may be carried out in windows, the number of windows and their respective scopes on a display screen have increased. As a result, the available area within individual windows may often be limited. Consequently, the computer controlled interactive display technology is seeking implementations for simplifying user interactive display interfaces and better organizing such interfaces so as to reduce the apparent clutter on the interfaces resulting from the proliferation of windows and the attendant increase in icons and other displayed data associated with such windows.

### SUMMARY OF THE PRESENT INVENTION

The present invention provides a user friendly display interface system for computer controlled displays with an expedient for improving the organization of such interfaces. The invention provides a virtual three-dimensional user interactive control button comprising a first face in a first of said three-dimensions including a first user interactive element enabling a user to select a first function; a second face in a second of said three-dimensions including a second user interactive element enabling a user to select a second function; and a third face in a third of said three-dimensions including a third user interactive element enabling a user to select a third function. By combining such sets of three-interactive elements, such as icons, into unitary compact and concise control buttons, considerable display space is conserved. Also, if the functions of the combined elements are related to each other, there is a considerable improvement in the organization of the display workspace.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a block diagram of an interactive data processor controlled display system including a central processing unit on which the present invention involving three-dimensional control buttons may be practiced;

FIG. 2 is a diagrammatic illustration of a virtual three-dimensional control button which may be used in the present invention;

FIG. 3 is a diagrammatic illustration of another virtual three-dimensional control button which may be used in the present invention;

FIG. 4 is a diagrammatic illustration of a display window in which the control buttons of FIGS. 2 and 3 are being used;

FIG. 5 is the display window of FIG. 4 after an interactive element or icon in a control button has been selected; and

FIG. 6 is a flow chart setting forth the basic programming units which have to be set up in order to practice an illustrative embodiment of the present invention.

### DETAILED DESCRIPTION OF THE PREFERRED EMBODIMENT

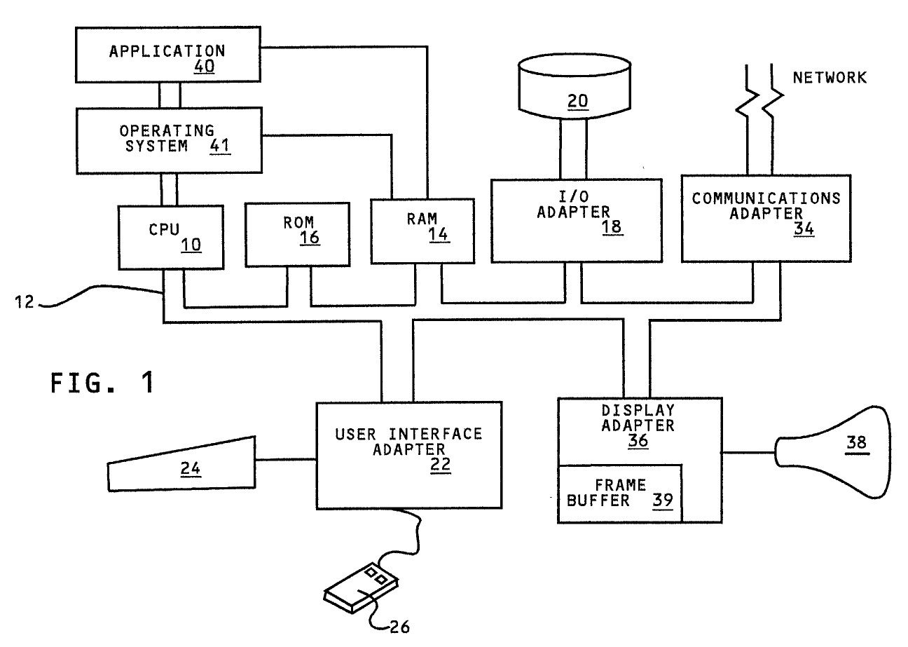

Referring to FIG. 1, a typical data processing system is shown which may function as the computer controlled display terminal used to implement the use of the three-dimensional control buttons of the present invention. A central processing unit (CPU) 10, such as one of the PC microprocessors distributed by International Business Machine Corporation (IBM) or workstations, e.g. RISC System/6000™ (RS/6000) (RISC System/6000 is a trademark of IBM) series available from IBM, is provided and interconnected to various other components by system bus 12. An operating system 41 runs on CPU 10, provides control and is used to coordinate the function of the various components of FIG. 1. Operating system 41 may be one of the commercially available windows type of operating systems, such as the AIX 6000™ operating system or Microsoft's Windows98™ or WindowsNT™, as well as the UNIX and AIX operating systems. Application programs 40 controlled by the system are moved into and out of the main memory, Random Access Memory (RAM), 14. These programs include the program of the present invention, to be subsequently described, to provide three-dimensional control buttons. A read only memory (ROM) 16 is connected to CPU 10 via bus 12 and includes the Basic Input/Output System (BIOS) that controls the basic computer functions. RAM 14, I/O adapter 18 and communications adapter 34 are also interconnected to system bus 12. It should be noted that software components including the operating system 41 and the application 40 are loaded into RAM 14, which is the computer system's main memory. I/O adapter 18 may be a small computer system adapter that communicates with the disk storage device 20, i.e. a hard drive. Communications adapter 34 interconnects bus 12 with an outside network enabling the data processing system to communicate with other such systems. In present day systems, windowed data may be transmitted from other computer stations in a network, such as the Internet or World Wide Web (Web). I/O devices are also connected to system bus 12 via user interface adapter 22 and display adapter 36. Keyboard 24 and mouse 26 are connected to bus 12 through user interface adapter 22. It is through such input devices that the user interactive functions involved in the displays of the present invention may be implemented. Display adapter 36 includes a frame buffer 39, which is a storage device that holds a representation of each pixel on the display screen 38. Images may be stored in frame buffer 39 for display on monitor 38.

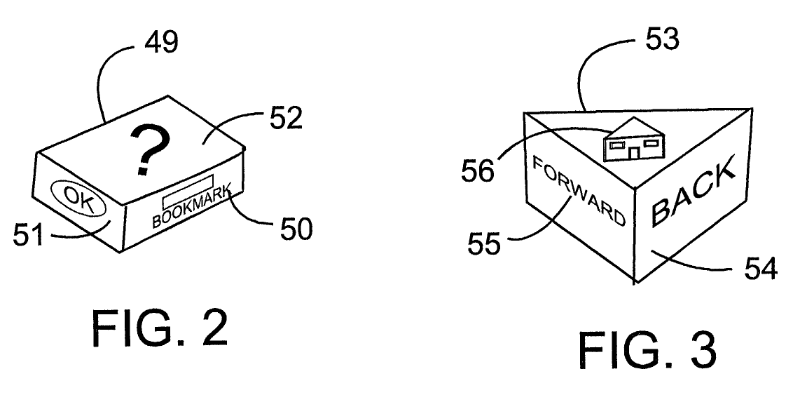

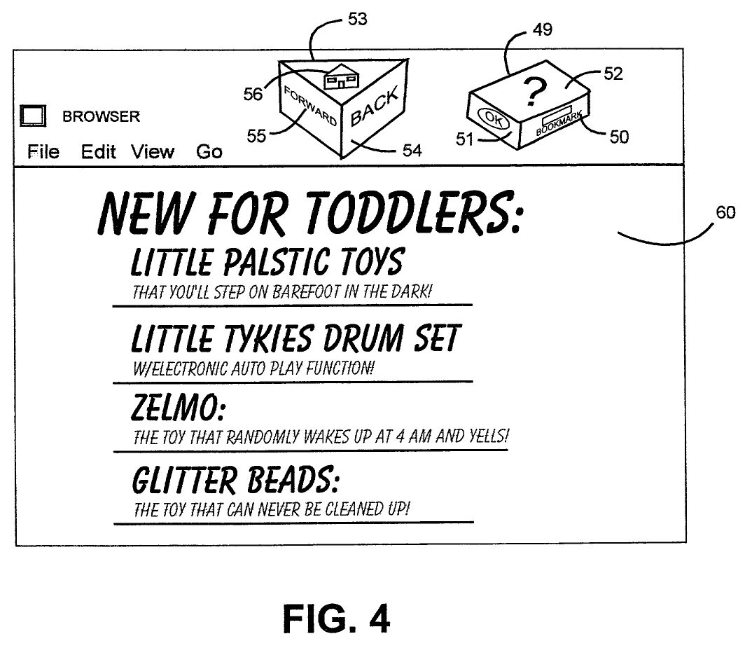

There will now be described some simple illustrations of the present invention with respect to the display screens of FIGS. 2 through 5. When the screen images are described, it will be understood that these may be rendered by storing image and text creation programs, such as those in any conventional window operating system in the RAM 14 of the system of FIG. 1. The operating system is diagrammatically shown in FIG. 1 as operating system 41. The display screens of FIGS. 3 through 4 are presented to the viewer on display monitor 38 of FIG. 1. In accordance with conventional techniques, the user may control the screen interactively through a conventional I/O device, such as mouse 26 of FIG. 1, which operates through user interface 22 to call upon programs in RAM 14 cooperating with the operating system 41 to create the images in frame buffer 39 of display adapter 36 to control the display on monitor 38.

With reference to FIG. 2, there is shown a three-dimensional control button which may be rendered and displayed by the processes described above. As will be hereinafter described in additional detail, this three-dimensional button has three faces used for different but related functions. Icon face 50 of control button may be selected to bring up a menu of choices relative to bookmaking. Icon face 51 may be used to enter or submit the choices made from the menu brought up by icon face 50, while “?” icon face 52 may be selected to bring up Help with respect to the functions and operations of control button 49. Likewise, control button 53 in FIG. 3 also performs a different set of related functions with respect to received Web pages, which will be also hereinafter described. Icon face 54 will move the viewer backwards through a sequence of received Web pages while icon face 55 may be selected to move the viewer forward through the sequence of received Web pages. Icon face 56 returns the viewer to the home page or starting point.

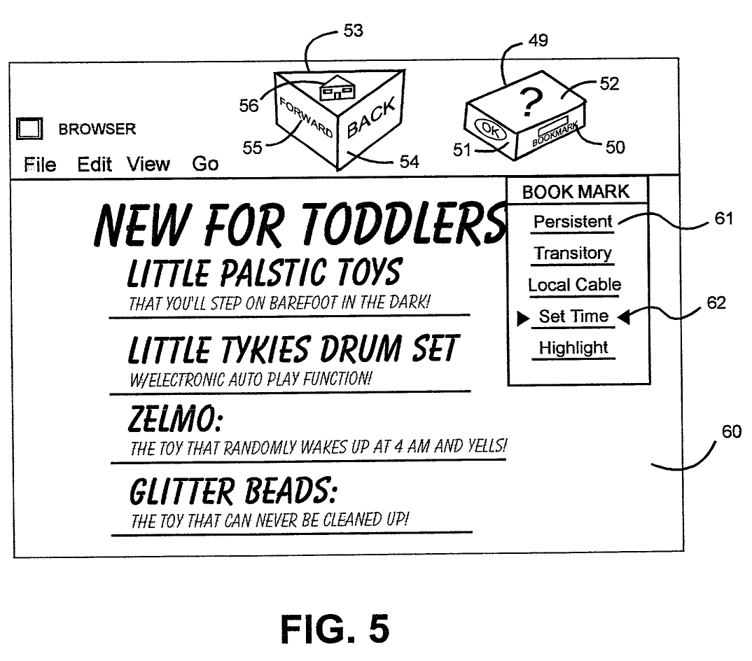

In the illustrative display screen of FIG. 4, there is shown a Web browser window with a Web page 60 at a Web receiving display station with the three-dimensional control buttons of FIGS. 2 and 3 shown as operative control buttons. The size of the control buttons 53 and 49 has been exaggerated for clarity in the illustration. Let us assume that a user wishes to bookmark the displayed Web page. He selects icon face 50, as shown in FIG. 5, a bookmark menu 61 comes down which gives the user five bookmarking options. The user may conventionally scroll up and down this menu via item indicator 62, which is conventionally mouse controlled. When the user makes a choice, he presses the “OK” icon 51 to enter or submit his choice. Should the user need help, he presses the “?” icon 52. The above-described control button 53 functions similarly to perform its back, forward and home functions with respect to the displayed Web pages 60.

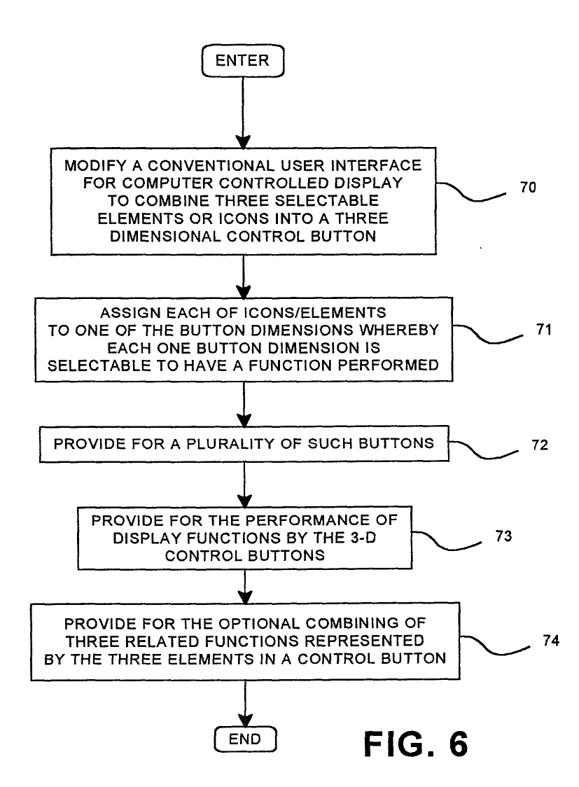

Now, with reference to FIG. 6, there will be described a process implemented by a program according to the present invention for developing and using virtual three-dimensional control buttons. We are using the term “virtual” since the three-dimensional buttons are developed and used on a two-dimensional display. The above-described technology covers the conventional rendering of such three-dimensional images. A process is provided for modifying any conventional graphical user display interface to combine three selectable elements or icons into a unitary three-dimensional control button, step 70. The process provides for assigning each of three of the icon/elements respectively to one of the control button faces (dimensions), whereby each one dimension on the button is selectable to have a function performed, step 71. The process provides for a plurality of such buttons, step 72. The process further provides for the display system performing the selected functions in a conventional manner, i.e. as if a conventional discrete icon had been selected, step 73. Optionally, but preferably, the functions represented by the three elements in the control button are related, step 74.

It should be noted that the programs covered by the present invention may be stored outside of the present computer systems until they are required. The program instructions may be stored in another readable medium, e.g. in a disk drive associated with the desktop computer or in a removable memory, such as an optical disk for use in a CD ROM computer input or in a floppy disk for use in a floppy disk drive computer input. Further, the program instructions may be stored in the memory of another computer prior to use in the system of the present invention and transmitted over a network when required by the user of the present invention.

One skilled in the art should appreciate that the processes controlling the present invention are capable of being distributed in the form of computer readable media of a variety of forms.

Although certain preferred embodiments have been shown and described, it will be understood that many changes and modifications may be made therein without departing from the scope and intent of the appended claims.

What is claimed is:

1. In a computer controlled user interactive display interface, a virtual three-dimensional control button comprising:
a first face in a first of said three dimensions including a first user interactive element enabling a user to select a first function;
a second face in a second of said three dimensions including a second user interactive element enabling a user to select a second function; and
a third face in a third of said three dimensions including a third user interactive element enabling a user to select a third function.

2. The computer controlled user interactive display interface of claim 1 including a plurality of said virtual three-dimensional control buttons.

3. The virtual three-dimensional control button of claim 1 wherein a plurality of the user interactive elements are icons.

4. The virtual three-dimensional control button of claim 1 wherein said functions controlled by said control buttons are display functions.

5. The virtual three-dimensional control button of claim 1 wherein said first, second and third functions are related to each other.

6. In a computer controlled method for providing a user interactive display interface, a method for enabling user interaction with first, second and third user interactive elements, comprising:
displaying said first user interactive element on a first face in a first dimension of a virtual three-dimensional control button;
displaying said second user interactive element on a second face in a second dimension of a virtual three-dimensional control button; and
displaying said third user interactive element on a third face in a third dimension of a virtual three-dimensional control button.

7. The method of claim 6 wherein a plurality of said virtual three-dimensional control buttons are displayed.

8. The method of claim 6 wherein a plurality of the user interactive elements are icons.

9. The method of claim 6 wherein said functions controlled by said control buttons are display functions.

10. The method of claim 6 wherein said first, second and third functions are related to each other.

11. A computer program having program code included on a computer readable medium for providing a virtual three-dimensional control button in a computer controlled user interactive display interface comprising:
means for providing a first face in a first of said three dimensions including a first user interactive element enabling a user to select a first function;
means for providing a second face in a second of said three dimensions including a second user interactive element enabling a user to select a second function; and
means for providing a third face in a third of said three dimensions including a third user interactive element enabling a user to select a third function.

12. The computer program of claim 11 wherein a plurality of said virtual three-dimensional control buttons are provided.

13. The computer program of claim 11 wherein a plurality of the user interactive elements are icons.

14. The computer program of claim 11 wherein said functions controlled by said control buttons are display functions.

15. The computer program of claim 11 wherein said first, second and third functions are related to each other.
